(19) United States
(12) Patent Application Publication
(10) Pub. No.: US 2023/0083338 A1
(43) Pub. Date: Mar. 16, 2023

(54) A System to Authenticate a Product and a Method Thereof

(71) Applicant: SEPIO PRODUCTS PRIVATE LIMITED, Maharashtra (IN)

(72) Inventors: Murad Nathani, Maharashtra (IN); Paul Abner Noronha, Maharashtra (IN); Darshan Dhruman Gandhi, Maharashtra (IN); Dattaprasad Narayan Kamat, Maharashtra (IN)

(21) Appl. No.: 17/799,128

(22) PCT Filed: Mar. 26, 2020
(86) PCT No.: PCT/IB2020/052853

§ 371 Date: Aug. 11, 2022

(30) Foreign Application Priority Data
Feb. 21, 2020 (IN) 202021007516

(51) Int. Cl. G06Q 30/00

(52) U.S. Cl. CPC G06Q 30/0185; G06K 7/1417

(57) ABSTRACT

The present disclosure envisages the field of authenticate a product. A system (100) to authenticate a product comprises a user device (102), a sensing module (104), a reference capturing module (106), a recognition module (108) and a redirection module 110). The user device (102) is configured to scan a visual of a product. The sensing module (104) is configured to receive and sense presence of a unique code in the visual. The reference capturing module (106) is configured to capture, process and generate an ID part one and an ID part two from the received visual. The recognition module (108) located on a remote server (118) processes the ID part one and ID part two to recognize and fetch a validation system credential. The redirection module (110) is configured receive the ID part one and the validation system credential to access a validation system to authenticate the ID part one.

### FIELD

The present invention belongs to system and method for product authentication.

### Definitions

As used in the present disclosure, the following terms are generally intended to have the meaning as set forth below, except to the extent that the context in which they are used indicate otherwise.

The expression “unique code” used hereinafter in this specification refers to, but is not limited to, a random number, a bar code, a URL QR Code, a PDF QR Code, Image QR Code, an RFID code, SQRC, frame QR, micro QR code, iQR code, text QR code and radioactive codes.

### BACKGROUND

The background information herein below relates to the present disclosure but is not necessarily prior art.

Currently available product authentication systems and methods facilitate a consumer to verify the authenticity of the product with the help of a unique code provided on the packaging of a product. The unique code is either visible or hidden under a scratch label or within the packaging, and are accessible to a consumer to verify authenticity of their purchase. These unique codes may be used in combination as well. The consumer may verify this unique number in various ways which includes scanning the unique code printed on the packaging via a mobile app to authenticate the code in-app. Alternatively, the web url is coded into the QR code which launches the webpage of the verification authority and verify the code in the mobile browser. Alternately, the unique code can be entered on a webpage provided by the verification authority/brand owner to verify the authenticity of the product. The code may also be sent as an SMS to a mobile number for verification. The unique code may or may not be terminated once scanned for the first time. By terminating a unique code, any subsequent scan of the same unique code by provided on a different product will reveal that the unique code has already been scanned or verified once and hence could be a counterfeit. Thus, a counterfeiter making copies of a genuine unique code can be deterred.

However, the drawback of the conventional system and method is that a counterfeiter could create a completely parallel system for verification to easily mislead the consumer can to a counterfeit portal. Moreover, a similar sounding name or verification number of the brand or the product may deceive a consumer into verifying a counterfeit product on a fake authentication portal.

There is, therefore, felt a need to develop a system and method that can address the aforesaid drawbacks of the conventional system to authenticate a product and a method thereof.

### Objects

Some of the objects of the present disclosure, which at least one embodiment herein satisfies, are as follows:

An object of the present disclosure is to provide a system to authenticate a product and a method thereof.

Another object of the present disclosure is to provide a system to authenticate a product and a method thereof that creates a streamlined and automated verification of a product.

Yet another object of the present disclosure is to provide a system to authenticate a product and a method thereof that is reliable.

Still another object of the present disclosure is to provide a system to authenticate a product and a method thereof which avoid errors in accessing the genuine websites and/or systems for verification and authentication.

Yet another object of the present disclosure is to provide a system to authenticate a product and a method thereof that prevents redirection to fake parallel verification portals and/or systems.

Still another object of the present disclosure is to provide a system to authenticate a product and a method thereof that identifies a counterfeit product.

Yet another object the present disclosure is to provide a system to authenticate a product and a method thereof that is easily accessible.

Other objects and advantages of the present disclosure will be more apparent from the following description, which is not intended to limit the scope of the present disclosure.

### SUMMARY

The present disclosure envisages a system to authenticate a product comprises a user device, a sensing module, a recognition module and a redirection module.

The user device is configured to scan a visual of a product.

The sensing module is configured to receive the visual and further configured to sense presence of a unique code in the visual.

The reference capturing module is configured to cooperate with the sensing module to capture the sensed unique code along with the visual, and further configured to process and generate an ID part one and an ID part two from the visual.

The recognition module located on a remote server and is communicatively coupled to the reference capturing module. The recognition module comprises a processing module, a repository and a crawler and extractor.

The processing module is configured to cooperate with the reference capturing module to receive the ID part one and ID part two and further configured to process a plurality of parts present in the ID part one and the ID part two.

The repository is configured to store a first look up table having a list of a plurality of image recognition and machine learning rules and a second look up table to store a list of a plurality of authentication system credential.

The crawler and extractor is configured to receive a first signal from the processing module to crawl through the first look up table and extract the image recognition and machine learning rules to identify the ID part two and further configured to receive a second signal from the processing module to crawl through the second look up table and extract the authentication system credential corresponding to the identified ID part two.

The redirection module communicatively coupled to the server, the redirection module is configured to cooperate with the recognition module to receive the ID part one along with the authentication system credential, and further configured to access an authentication system using the authentication system credential to authenticate the ID part one.

The present disclosure also envisages a method for authenticating a product.

### BRIEF DESCRIPTION OF THE ACCOMPANYING DRAWING

A system to authenticate a product and a method thereof, of the present disclosure will now be described with the help of the accompanying drawing, in which:

FIG. 1 illustrates a block diagram of the system to authenticate a product, in accordance with an embodiment of the present disclosure; and

FIGS. 2a and 2b illustrate a flow diagram depicting a method to authenticate a product, in accordance with an embodiment of the present disclosure.

LIST OF REFERENCE NUMERALS

| | |
|---|---|
| 100 | system |
| 102 | user device |
| 104 | sensing module |
| 106 | reference capturing module |
| 108 | recognition module |
| 110 | redirection module |
| 112 | processing module |
| 114 | repository |
| 116 | crawler and extractor |
| 118 | remote server |

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

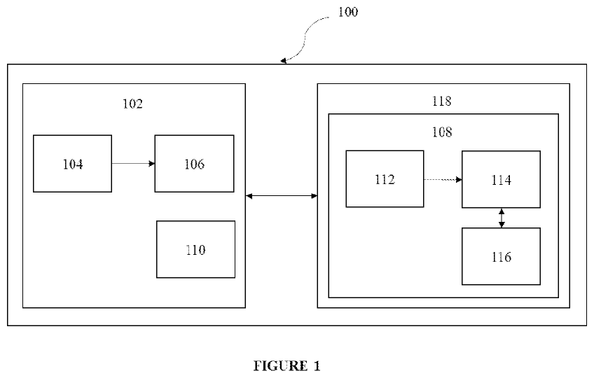

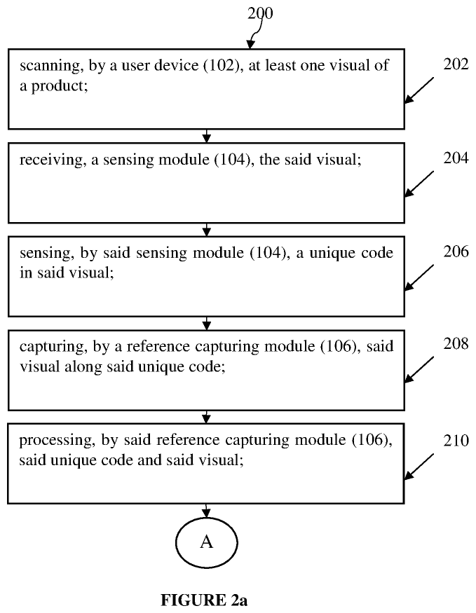

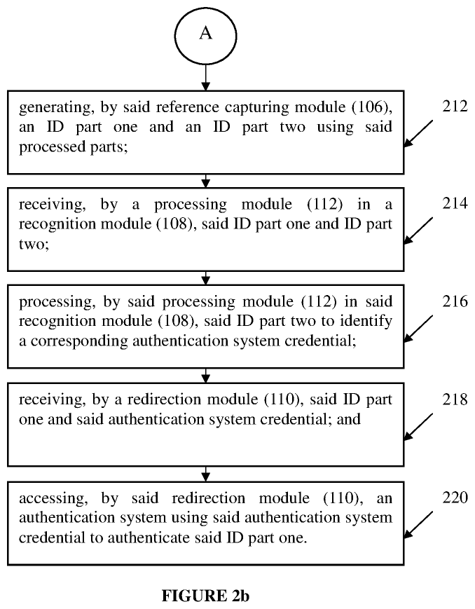

Conventional system and method the counterfeiter could create a completely parallel system for authentication to easily mislead the consumer can to a counterfeit portal. To overcome this problem, a system (hereinafter referred to as “system (100”)) and method (hereinafter referred to as “method (200)) to authenticate a product of the present disclosure, is described with reference to FIG. 1, FIG. 2a and FIG. 2b.

Referring to FIG. 1, the system (100) comprises, a user device (102), a sensing module (104), a reference capturing module (106), a recognition module (108) and a redirection module (110). The user device (102) is configured to scan a visual of a product.

In an embodiment, the user device (102) may be selected from the group consisting of, but is not limited to, a mobile phone, a smartphone, an iPad, a tablet, a palmtop, code scanning cameras, smart watch and code scanning equipment.

The sensing module (104) is configured to receive the visual and further configured to sense presence of a unique code in the visual.

In an embodiment, the unique code can be a selected from the group consisting of, but is not limited to a QR code, a watermark, a texture, a barcode, an invisible UV image, and a randomly generated numbers or a combination thereof. In another embodiment, the unique code can be overt or covert. In another embodiment, the unique code can be over the surface of the product or hidden under a removable layer on the surface of the product.

The reference capturing module (106) configured to cooperate with the sensing module (104) to receive the sensed unique code along with the visual, and further configured to process and generate an ID part one and an ID part two from the visual.

In an embodiment, the reference capturing module (106) can be further configured to scan from a group of a visible image, an invisible image, a visible unique code or an invisible unique code or a combination thereof.

In another embodiment, the reference capturing module (106) is further configured to extract the sensed unique code as ID part one and remaining the visual as ID part two from the visual.

The recognition module (108) located on a remote server (118) communicatively coupled to the reference capturing module (106), the recognition module (108) is comprising a processing module (112), a repository (114) and a crawler and extractor (116).

In an embodiment, the recognition module (108) is configured to use machine learning techniques and image recognition techniques to process the ID part one and ID part two.

The processing module (112) configured to cooperate with the reference capturing module (106) to receive the ID part one and ID part two and further configured to process a plurality of parts present in the ID part one and the ID part two.

The repository (114) configured to store a first look up table having a list of a plurality of image recognition and machine learning rules and a second look up table to store a list of a plurality of authentication system credential.

In an embodiment, the authentication system credential includes at least one of website address and application link.

In another embodiment, the authentication system credential can be sourced directly from an authentication authority of the product by know your customer documentations.

The crawler and extractor (116) configured to receive a first signal from the processing module (112) to crawl through the first look up table and extract the image recognition and machine learning rules to identify the ID part two and further configured to receive a second signal from the processing module (112) to crawl through the second look up table and extract the authentication system credential corresponding to the identified ID part two.

The redirection module (110) communicatively coupled to the server (118), the redirection module (110) is configured to cooperate with the recognition module (108) to receive the ID part one along with the authentication system credential, and further configured to access an authentication system using the authentication system credential to authenticate the ID part one.

In an embodiment, the redirection module (110) is configured to force open an authentication interface on the user device (102) using the received authentication system credential to authenticate the ID part one.

FIGS. 2a and 2b illustrate a flow diagram of the method (200) for authenticating a product. The method comprising the following steps:
At Step 202: scanning, by a user device (102), at least one visual of a product;
At Step 204: receiving, a sensing module (104), the visual;
At Step 206: sensing, by the sensing module (104), a unique code in the visual;
At Step 208: capturing, by a reference capturing module (106), the visual along the unique code;
At Step 210: processing, by the reference capturing module (106), the unique code and the visual;
At Step 212: generating, by the reference capturing module (106), an ID part one and an ID part two using the processed parts;
At Step 214: receiving, by a processing module (112) in a recognition module (108), the ID part one and the ID part two;
At Step 216: processing, by the processing module (112) in the recognition module (108), the ID part two to identify a corresponding authentication system credential;
At Step 218: receiving, by a redirection module (110), the ID part one and the authentication system credential; and
At Step 220: accessing, by the redirection module (110), an authentication system using the authentication system credential to authenticate the ID part one.

In an embodiment, the steps of receiving (214) and processing (216), by the recognition module (108) are performed on the remote server (118).

In an embodiment, the authentication system validates the ID part one and display status of authenticity associated with the product on the user device (102) in further steps.

### Technical Advancements

The present disclosure described herein above has several technical advantages including, but not limited to, system to authenticate a product and a method thereof, which:
creates a streamlined and automated verification of a product.
authenticate a product and a method thereof that is reliable.
avoid errors in accessing the genuine websites and/or systems for verification and authentication.
prevents redirection to fake parallel verification portals and/or systems.
identifies a counterfeit product.
is easily accessible.

The foregoing disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description.

Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system (100) to authenticate a product, said system (100) comprising:
a user device (102) configured to scan a visual of a product;
a sensing module (104) configured to receive said visual and further configured to sense presence of a unique code in said visual;
a reference capturing module (106) configured to cooperate with said sensing module (104) to capture said sensed unique code along with said visual, and further configured to process and generate an ID part one and an ID part two from said visual;
a recognition module (108) located on a remote server (118) communicatively coupled to said reference capturing module (106), said recognition module (108) comprising:
a processing module (112) configured to cooperate with said reference capturing module (106) to receive said ID part one and ID part two and further configured to process a plurality of parts present in said ID part one and said ID part two;
a repository (114) configured to store a first look up table having a list of a plurality of image recognition and machine learning rules and a second look up table to store a list of a plurality of authentication system credential; and
a crawler and extractor (116) configured to receive a first signal from said processing module (112) to crawl through the first look up table and extract said image recognition and machine learning rules to identify said ID part two and further configured to receive a second signal from said processing module (112) to crawl through the second look up table and extract said authentication system credential corresponding to said identified ID part two; and
a redirection module (110) communicatively coupled to said server (118), said redirection module (110) is configured to cooperate with said recognition module (108) to receive said ID part one along with said authentication system credential, and further configured to access an authentication system using said authentication system credential to authenticate said ID part one.

2. The system (100) as claimed in claim 1, said reference capturing module (106) configured to extract said sensed unique code as ID part one and remaining said visual as ID part two from said visual.

3. The system (100) as claimed in claim 1, said recognition module (108) is configured to use machine learning techniques and image recognition techniques to process said ID part one and ID part two.

4. The system (100) as claimed in claim 1, said authentication system credential includes at least one of website address and application link.

5. The system (100) as claimed in claim 1, said redirection module (110) configured to force open an authentication interface on the user device (102) using said received authentication system credential to authenticate said ID part one.

6. A method (200) for authenticating a product, said method comprising the following steps:
scanning (202), by a user device (102), at least one visual of a product;
receiving (204), a sensing module (104), the said visual;
sensing (206), by said sensing module (104), a unique code in said visual;
capturing (208), by a reference capturing module (106), said visual along said unique code;
processing (210), by said reference capturing module (106), said unique code and said visual;
generating (212), by said reference capturing module (106), an ID part one and an ID part two using said processed parts;
receiving (214), by a processing module (112) in a recognition module (108), said ID part one and ID part two;
processing (216), by said processing module (112) in said recognition module (108), said ID part two to identify a corresponding authentication system credential;
receiving (218), by a redirection module (110), said ID part one and said authentication system credential; and
accessing (220), by said redirection module (110), an authentication system using said authentication system credential to authenticate said ID part one.

7. The method as claimed in claim 6, wherein the steps of receiving (214) and processing (216), by said recognition module (108) are performed on said server (118).
